(19) United States
(12) Patent Application Publication
(10) Pub. No.: US 2003/0073424 A1
(43) Pub. Date: Apr. 17, 2003

(54) System and method for elimination of spectral congestion to allow transmission of an emergency communication

(76) Inventor: Patrick Nunally, Escondido, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/242,500

(22) Filed: Sep. 11, 2002

Related U.S. Application Data
(60) Provisional application No. 60/323,209, filed on Sep. 12, 2001.

(51) Int. Cl. H04B 7/00; H04B 17/00; H04M 11/00; H04B 7/005; H04B 7/01; H04B 7/015; H04B 15/00; H04Q 7/20

(52) U.S. Cl. 455/404; 455/512; 455/67.3; 455/501

(57) ABSTRACT

A method and system for completing a communication of high importance on a congested communication system. The communication is transmitted between a communication device (e.g. a cordless telephone, a cellular telephone, a pager, a digital communication device, a personal digital assistant, or a wireless local loop device) and a base station. If uncongested channels are not available for communications between the communication device and the base station, a disabling signal is transmitted instructing emitting devices in the vicinity to reduce their emitted transmissions, thereby creating uncongested channels. Additionally, the communication device and base station can incrementally increase the power of transmitted signals until communications are established.

### RELATED APPLICATIONS

This application claims priority to U.S. Provisional Patent Application No. 60/323,209, filed on Sep. 12, 2001, which is hereby incorporated by reference in its entirety.

### BACKGROUND OF THE INVENTION

1. Field of the Invention

This invention relates generally to electronic transmitting devices and in particular to a system and a method for the elimination of interference when a telephone call is made.

2. Description of the Related Art

Cordless telephones consisting of a handset 120 and a base station 110, that communicate via a radio link were introduced in the 1980s. When first introduced, there were relatively few cordless telephones with transceivers that transmitted over relatively short distances in the 43-50 MHz frequency band. The ability to roam freely about the home or office while using the cordless phone caused their popularity to grow and cordless telephones are now commonplace in nearly every home.

Recently, digital cordless telephones have been introduced that transmit and receive digital RF signals in the 900 MHz frequency band and the 2.4 GHz frequency band. Each frequency band (i.e., 50 MHz, 900 MHz or 2.4 GHz) is subdivided into different increments or channels. When making a telephone call, the handset 120 searches for a pair of frequencies (channels) within the frequency band, that is not already in use, in order to talk to the base station 110. The higher frequency ranges enable the base station 110 and handset 120 to transmit clearer signals over greater distances. However, the increased range also increases the area in which the telephone can cause interference with other telephones attempting to operate in the same frequency band. Additionally, cordless telephone systems using direct sequence spread spectrum (DSSS) or frequency hopping spread spectrum (FHSS) modulation are permitted to use even higher power levels, further increasing the operating and interference range. Cordless telephones can experience interference problems when noise or other signals appearing on the channel utilized by the cordless telephone are encountered.

Interference can be caused by other cordless telephones, or any of numerous devices such as baby monitors, wireless speakers and similar devices utilizing frequencies in the telephone's frequency band. Even telephones using DSSS encounter interference problems. For example, if two frequency hopping cordless telephones that are hopping at different rates and operating within reception range of each other, appear on the same channel at the same time, there is a likelihood of interference occurring between these two telephones. This interference could, at a minimum, cause a distortion of information and, at worst, a loss of synchronization between the handset 120 and the associated base station 110 of one and possibly both of these cordless telephones. This interference could continue as both cordless telephones continue to hop to and appear on this channel and possibly other common channels at the same time.

As cordless telephones and other devices using the same unregulated frequency bands become more prevalent, it becomes more likely that uncongested channels will not be found when the cordless telephone attempts to locate channels to establish communication between the handset 120 and the base station 110. When this happens, the user will be temporarily unable to use the cordless telephone. This can be a minor inconvenience when the telephone call is relatively unimportant, but this situation can have dire consequences if the user is attempting to contact emergency personnel to report a medical emergency, fire or other potentially life-threatening situation. Accordingly, it would be desirable to have a system and method that allows a telephone to selectively free up channels or override interfering signals when an emergency situation arises so that the telephone call can be made immediately on demand.

In addition, other communication devices, such as cellular telephones, pagers, digital communication devices (such as personal digital assistants), and wireless local loop devices may also transmit communication signals in congested environments. As such, a system and method that allows any communication device to selectively free up communication channels or override interfering communication signals when an emergency situation arises is desired.

### SUMMARY OF THE INVENTION

One embodiment of the invention may be a method of establishing communications between a mobile device and a base station in a communication system comprises a plurality of communication channels capable of carrying a communication signal between the mobile device and the base station. The method comprises determining if at least one of the plurality of communication channels may be available for transmitting the communication signal between the mobile device and the base station, determining if the communication signal is a high importance communication signal, and upon determining that each of the at least one of the plurality of communication channels may be not available for transmitting the communication signal and that the communication signal is a high importance communication signal, transmitting the communication signal between the mobile device and the base station at an increased power level on the at least one of the plurality of communication channels such that the communication signal may be transmitted between the mobile device and the base station. Each of the plurality of communication channels may not be available if the communication channel cannot transmit the communication signal between the mobile device and the base stations. Each of the plurality of communication channels may not be available if a measure of quality of the communication channel may be less than a predetermined level. Each of the plurality of communication channels may be available if there are substantially no transmissions in a frequency band defining the communication channel. The act of determining if the communication signal is a high importance communication signal may be performed by the mobile device. The method may further comprise transmitting a disable signal instructing an emitting device to reduce emitting transmissions in the at least one of the plurality of communication channels that may be not available if each of the plurality of communication channels may be not available and the communication signal is a high importance communication signal. The high importance communication signal may be an emergency communication signal. The communication signal may be a telephone call. The mobile device may be a cellular telephone. The high importance communication signal may be a call to a 9-1-1 operator. The mobile device may be a cordless telephone. The high importance communication signal may be a call to a 9-1 -1 operator. The mobile device may be a digital communication device. The mobile device may be a personal digital assistant (PDA). The transmitting the communication signal at an increased power level may further include incrementally and repeatedly increasing the power level of the transmitted communication signal until the transmitted communication signal may be transmitted between the device and the base station. A processor may be disposed in the mobile device determines if the telephone call is a high importance communication signal using keystrokes entered on a keypad located on the mobile device. Keystrokes entered may define an emergency telephone number. A dedicated button on the mobile device may be depressed when the communication signal is a high importance communication signal. The communication signal may be a duplex communication signal.

Another embodiment of the invention may be a method of establishing communications between a communication device and a base station in a communication system comprises a plurality of communication channels. The method comprises determining if uncongested channels are available for transmitting a communication signal between the communication device and the base station, determining if the communication signal is a high-importance communication signal, transmitting a disable signal instructing an emitting device to reduce emitting transmissions in a congested communication channel if uncongested communication channels are not available and the communication signal is a high-importance communication signal, reducing the congestion of at least a pair of communication channels in response to receiving the disable signal, and transmitting the high-importance communication signal on the at least a pair of communication channels. The communication device may be one of a cordless telephone, a cellular telephone, a pager, a digital communication device, a personal digital assistant and a wireless local loop device. The high-importance communication signal may be an emergency communication signal. The emergency communication signal may be a telephone call from the mobile device to an emergency operator via the base station. The method may further comprise transmitting the communication signal between the communication device and the base station at an increased power level on at least one of the communication channels if the act of reducing does not reduce the congestion of at least a pair of communication channels to a predetermined amount. The disable signal may be transmitted from a transmitter dedicated to transferring the disable signal.

Another embodiment of the invention may be a communication system for use in an environment of spectral congestion. The system comprises a base station comprises a first transceiver configured to transmit and receive a communication signal via a communication channel, a processor configured to determine if the communication signal is a high-importance communication signal, and a communication device comprises a second transceiver configured to transmit and receive the communication signal via the communication channel, wherein when the communication channel is congested and the communication signal is a high-importance communication signal, the second transceiver transmits the communication signal at an increased power level on the communication channel such that the communication signal may be received by the base station. The communication device may be one of a cordless telephone, a cellular telephone, a pager, a digital communication device, a personal digital assistant and a wireless local loop device. The high-importance communication signal may be an emergency telephone call. The communication system may further comprise a transmitter disposed in the communication device configured to transmit a disable signal instructing an emitting device to reduce emitting transmissions in the communication channel when the communication channel is congested and the communication signal is a high-importance communication signal.

Another embodiment of the invention may be a communication system capable of establishing communications between a portable communication device and a base station in an environment of spectral congestion. The system comprises means for determining if uncongested channels are available for transmitting a communication signal between the portable communication device and the base station, means for determining if the communication signal is a high-importance communication signal, means for transmitting the communication signal from the portable communication device at an increased power level upon determining that no uncongested channels are available for transmitting the communication signal and determining that the communication signal is a high-importance communication signal. The cordless telephone system may further comprise means for transmitting a disable signal instructing an emitting device to reduce emitting transmissions in a congested channel if no uncongested channels are available for transmitting the communication signal and the communication signal is a high-importance communication signal. The means for transmitting the communication signal may increase the power level incrementally and repeatedly until the communication signal may be received by the base station. The means for determining if the communication signal is a high-importance communication signal may comprise a processor that determines if an emergency telephone call may be being made by the portable communication device based on keystrokes entered on a keypad disposed on the portable communication device.

Another embodiment of the invention may be a communication device capable of reducing spectral congestion in order to transmit a high importance communication signal. The device comprises a transmitter configured to transmit a communication signal on a communication channel, an input configured to receive a destination for the communication signal, a processor configured to determine if the communication signal is a high-importance communication signal, and wherein when the communication channel is congested and the communication signal is a high-importance communication signal, the transmitter transmits the communication signal at an increased power level on the communication channel. The input may comprise a keypad. The input may comprise a microphone. When the communication channel is congested and the communication signal is a high-importance communication signal the transmitter transmits a disable signal instructing an emitting device to reduce emitting transmissions in the communication channel. The communication device may be one of a cordless telephone, a cellular telephone, a pager, a digital communication device, a personal digital assistant and a wireless local loop device.

### BRIEF DESCRIPTION OF THE DRAWINGS

These and other objects and features of the invention will become more fully apparent from the following description and appended claims taken in conjunction with the following drawings, where like reference numbers indicate identical or functionally similar elements.

FIG. 1 is a block diagram of a system that eliminates spectral interference when making a telephone call, according to one embodiment of the invention.

FIG. 2 is a flow chart illustrating a method of disabling emissions of an interfering device or overpowering the interfering device to enable a telephone call to be made, according to one embodiment of the invention.

### DETAILED DESCRIPTION OF THE INVENTION

The following is a detailed description of embodiments of the invention. However, the invention can be embodied in a multitude of different ways as defined and covered by the claims. The invention is more general than the embodiments that are explicitly described, and accordingly, is not limited by the specific embodiments.

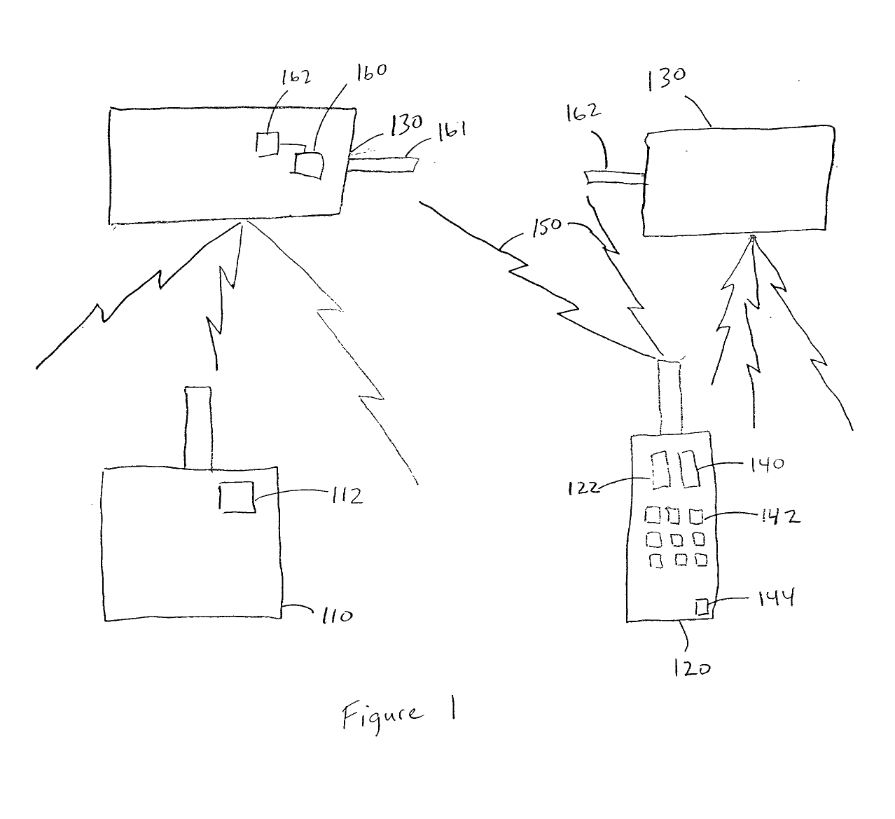

FIG. 1 is a schematic block diagram of a communications system 100. The communications system includes a cordless telephone base station 110 and a handset 120. The base station 110 communicates with the handset 120 in a predetermined frequency band using a pair of frequencies in that frequency band. The handset 120 includes a transceiver 122 that communicates to the base station 110 using one frequency and the base station 110 contains a transceiver 112 that communicates to the handset 120 using the second frequency. As one skilled in the art will recognize, the frequency band can be the 50 MHz, 900 MHz or 2.4 GHz frequency band utilized by cordless telephones, or any other frequency band approved by the FCC for use by cordless telephones. One of skill in the art will recognize that while the description contained herein discusses cordless telephones and cordless telephone systems, the systems and methods may be applicable to any communication system. For example, the systems and methods described herein may be applied to a communication system operating on a network using any available communication protocol, such as GSM, CDMA, TDMA, PCS, 802.11, Bluetooth, or HomeRF, for example. Likewise, the communication devices may comprise cellular telephones, pagers, digital communication devices (such as personal digital assistants), and wireless local loop devices, for example. In sum, the systems and methods described herein may be applied to any communication system, utilizing any type of communication network and any type of communication devices in order to provide a communication channel for high importance communications in a congested communication network.

When a user attempts to make a telephone call using the handset 120, circuitry in the handset 120 searches for an uncongested pair of duplex frequency channels within the predetermined frequency band that is not already in use in order to talk to the base station 110. Emitting devices 130 in the area can also be operating, and potentially, can be using all the frequencies in the band such that uncongested channels cannot be found. Where a congested channel is defined as a communications channel in which connection can not be made or more often where quality of service is poor. Emitting devices 130 may include other cordless telephones, computers, PDA's, radios, pagers, area monitors, baby monitors, wireless speakers and other devices capable of emitting signals.

The handset 120 contains a processor 140 for determining the intended nature or recipient of the telephone call. If uncongested channels are not found, the processor 140 determines if the intended telephone call is a high-importance call that requires priority treatment, such as, for example, an emergency call. The processor 140 determines if an emergency call is intended from the keystrokes entered on a keypad 142 on the handset 120, or a by the user depressing a dedicated button 144 on the handset. For example, if the keystroke sequence “9-1-1” is depressed on the keypad 142, the processor 140 recognizes that an emergency call is intended. Additionally, a voice command using voice recognition software or other methods of determine the nature of the intended call can be used.

If the processor 140 determines that the user is attempting to place an emergency call, the processor 140 causes the transceiver 122 to first send a disable signal 150. The transceiver 122 can transmit the disable signal 150 in an in-band or out of band frequency range. The disable signal 150 can take many forms, however, it is preferable that the disable signal 150 be a highly discernable signal coded with highly orthogonal codes which represent specific details of the restrictions, limitations or redirection commands for a single or multiple spectrums. This signal can be allotted to a dedicated channel or can be agile. Alternately, the handset 120 can have a separate transmitter for transmitting the disable signal 150.

The disable signal 150 is received by an emission restriction receiver 160 via an antenna 161 attached to the emitting device 130. The emission restriction receiver 160 parses the received disable signal 150 in order to determine if the emitting device 130 should alter, disable, limit or give preference to specific emissions. This parsed data is then sent from the emission restriction receiver 160 to a controller 162.

The controller 162 can be a baseband digital processor that is used to identify and alter performance of the emitting device 130. When the controller 162 receives the parsed data, the controller 162 causes the emitting device 130 to reduce emitting signals in the requested channels. In reducing emitted signal, the emitting device ceases emitting signals in the requested channels or reduces the power at which the device is transmitting. Alternately, the controller 162 causes the emitting device 130 to shift to a different channel.

In some situations, the emitting device 130 will not reduce emitting signals if the emitting device does not have an emission restriction receiver 160 or does not receive the disable signal 150. If the emitting device 130 does not respond to the disable signal 150, as indicated by continued interference on the requested channels, the processor 140 causes the transceiver 122 to increase the power of the transmitted signal in the desired channel between the handset 120 and the base station 110. Increasing the power increases the signal to noise ratio, thereby making it more likely that successful communication between the handset 120 and the base station 110 can be achieved. The transceiver 122 can increase power in increments so that unnecessary overpowering of the desired channels does not happen. For example, the transceiver 122 can first increase transmitting power by 50% and determine if successful communications between the handset 120 and base station 110 are achieved. If communications still are not achieved, the power can then be increase by 100% and so on until communications are achieved or maximum power is reached.

This embodiment of the invention has been described in the context of a cordless telephone transmission. However, the breadth of the invention covers a range of uses to eliminate spectral congestion. It is conceived that embodiments of the invention will be directed to limiting the signal emissions of mobile wireless devices and their components, or to tokens whose sole purpose is to clear a specific frequency spectrum so that emergency calls may be successfully completed.

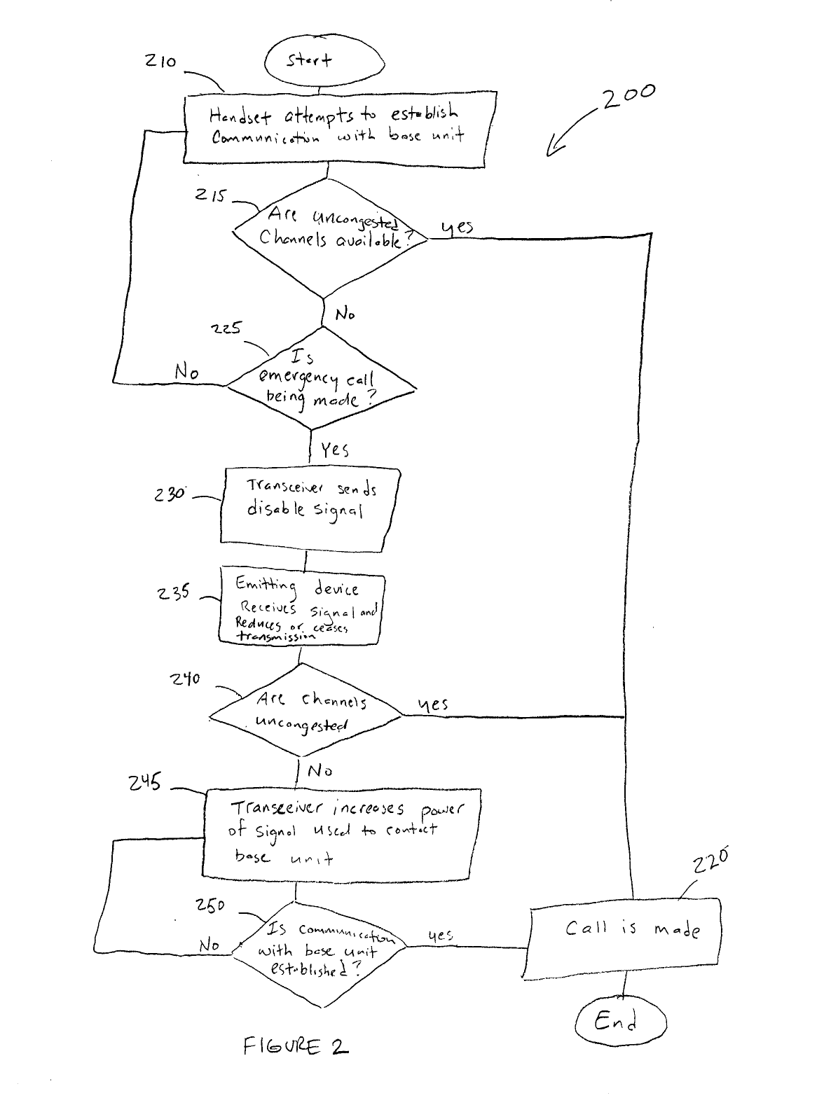

FIG. 2 is a flow chart illustrating a process of eliminating interference on the desired channels. In step 210, the handset 120 attempts to establish communications with the base station 110. In step 215, the processor 140 determines if uncongested channels are available. If uncongested channels are available, the process proceeds to step 220 and communications are established and the base station 110 makes the desired telephone call. If uncongested channels are not available, the process proceeds to step 225 wherein the processor 140 determines if an emergency call is being made. If an emergency call is not being made, the process returns to step 210. If an emergency call is being made, the process moves to step 230, wherein the transceiver 122 sends out a disable signal 150 to emitting devices 130 in the area of the handset 120. In step 235, if an emitting device 130 with an emission restriction receiver 160 receives the disable signal 150, the emitting device 130 either reduces the transmission power or ceases to emit transmissions.

In step 240, the processor 140 determines if channels have been freed up in response to the disable signal 150 and if communications with the base station 110 can be established. If channels have been freed up, the process proceeds to step 220 and the telephone call is made. If communications still can not be established, the process moves to a step 245, wherein the transceiver 122 increases the power that it is using in attempts to contact the base station 110. In step 250, the processor 140 determines if communications have been established in response to increasing the transmitted power. If communications have been established, the process proceeds to step 220 and the telephone call is made. If communications still have not been established, the process returns to step 245 wherein the transmit power is increased again. The process continues until either communications with the base station are established or the maximum transmitting power is reached.

Thus, the invention overcomes the longstanding problem in the technology of being able to make high-importance calls in an environment of spectral congestion by freeing designated channels or increasing transmission power to override the congestion and complete the call. Although the invention has been described in the context of using a cordless telephone to make an emergency telephone call, it is anticipated that the breadth of the invention covers other types telephone calls that are deemed by the caller to be of high importance. For example, government leaders, police, doctors, and persons with other jobs considered highly important or dealing with time sensitive information can have access to cordless telephones that can operate in congested conditions.

Specific parts, shapes, materials, functions and modules have been set forth, herein. However, a skilled technologist will realize that there are many ways to fabricate the system of the present invention, and that there are many parts, components, modules or functions that may be substituted for those listed above. While the above detailed description has shown, described, and pointed out the fundamental novel features of the invention as applied to various embodiments, it will be understood that various omissions and substitutions and changes in the form and details of the components illustrated may be made by those skilled in the art, without departing from the spirit or essential characteristics of the invention.

What is claimed is:

1. A method of establishing communications between a mobile device and a base station in a communication system comprising a plurality of communication channels capable of carrying a communication signal between said mobile device and said base station, the method comprising:
determining if at least one of said plurality of communication channels is available for transmitting said communication signal between said mobile device and said base station;
determining if said communication signal is a high importance communication signal; and
upon determining that each of said at least one of said plurality of communication channels is not available for transmitting said communication signal and that said communication signal is a high importance communication signal, transmitting said communication signal between said mobile device and said base station at an increased power level on said at least one of said plurality of communication channels such that said communication signal is transmitted between said mobile device and said base station.

2. The method of claim 1, wherein each of said plurality of communication channels is not available if said communication channel cannot transmit said communication signal between said mobile device and said base stations.

3. The method of claim 1, wherein each of said plurality of communication channels is not available if a measure of quality of said communication channel is less than a predetermined level.

4. The method of claim 1, wherein each of said plurality of communication channels is available if there are substantially no transmissions in a frequency band defining said communication channel.

5. The method of claim 1, wherein said act of determining if said communication signal is a high importance communication signal is performed by said mobile device.

6. The method of claim 1, further comprising:
transmitting a disable signal instructing an emitting device to reduce emitting transmissions in said at least one of said plurality of communication channels that is not available if each of said plurality of communication channels is not available and the communication signal is a high importance communication signal.

7. The method of claim 1, wherein said high importance communication signal is an emergency communication signal.

8. The method of claim 1, wherein said communication signal is a telephone call.

9. The method of claim 8, wherein said mobile device is a cellular telephone.

10. The method of claim 9, wherein the high importance communication signal is a call to a 9-1 -1 operator.

11. The method of claim 8, wherein said mobile device is a cordless telephone.

12. The method of claim 11, wherein the high importance communication signal is a call to a 9-1-1 operator.

13. The method of claim 1, wherein said mobile device is a digital communication device.

14. The method of claim 13, wherein said mobile device is a personal digital assistant (PDA).

15. The method of claim 1, wherein transmitting said communication signal at an increased power level further includes incrementally and repeatedly increasing the power level of the transmitted communication signal until said transmitted communication signal is transmitted between said device and said base station.

16. The method of claim 8, wherein a processor disposed in said mobile device determines if said telephone call is a high importance communication signal using keystrokes entered on a keypad located on said mobile device.

17. The method of claim 16, wherein the keystrokes entered define an emergency telephone number.

18. The method of claim 16, wherein a dedicated button on said mobile device is depressed when said communication signal is a high importance communication signal.

19. The method of claim 1, wherein said communication signal is a duplex communication signal.

20. A method of establishing communications between a communication device and a base station in a communication system comprising a plurality of communication channels, the method comprising:
determining if uncongested channels are available for transmitting a communication signal between said communication device and said base station;
determining if said communication signal is a high-importance communication signal;
transmitting a disable signal instructing an emitting device to reduce emitting transmissions in a congested communication channel if uncongested communication channels are not available and the communication signal is a high-importance communication signal;
reducing the congestion of at least a pair of communication channels in response to receiving said disable signal; and
transmitting said high-importance communication signal on said at least a pair of communication channels.

21. The method of claim 20, wherein said communication device is one of a cordless telephone, a cellular telephone, a pager, a digital communication device, a personal digital assistant and a wireless local loop device.

22. The method of claim 20, wherein said high-importance communication signal is an emergency communication signal.

23. The method of claim 22, wherein said emergency communication signal is a telephone call from said mobile device to an emergency operator via said base station.

24. The method of claim 20, further comprising transmitting said communication signal between said communication device and said base station at an increased power level on at least one of said communication channels if said act of reducing does not reduce the congestion of at least a pair of communication channels to a predetermined amount.

25. The method of claim 20, wherein said disable signal is transmitted from a transmitter dedicated to transferring said disable signal.

26. A communication system for use in an environment of spectral congestion, the system comprising:
a base station comprising a first transceiver configured to transmit and receive a communication signal via a communication channel;
a processor configured to determine if said communication signal is a high-importance communication signal; and
a communication device comprising a second transceiver configured to transmit and receive said communication signal via said communication channel, wherein when said communication channel is congested and said communication signal is a high-importance communication signal, said second transceiver transmits said communication signal at an increased power level on said communication channel such that said communication signal is received by said base station.

27. The communication system of claim 26, wherein said communication device is one of a cordless telephone, a cellular telephone, a pager, a digital communication device, a personal digital assistant and a wireless local loop device.

28. The communication system of claim 26, wherein said high-importance communication signal is an emergency telephone call.

29. The communication system of claim 26, further comprising a transmitter disposed in said communication device configured to transmit a disable signal instructing an emitting device to reduce emitting transmissions in said communication channel when said communication channel is congested and said communication signal is a high-importance communication signal.

30. A communication system capable of establishing communications between a portable communication device and a base station in an environment of spectral congestion, the system comprising:
means for determining if uncongested channels are available for transmitting a communication signal between said portable communication device and said base station;
means for determining if said communication signal is a high-importance communication signal;
means for transmitting said communication signal from said portable communication device at an increased power level upon determining that no uncongested channels are available for transmitting said communication signal and determining that said communication signal is a high-importance communication signal.

31. The cordless telephone system of claim 30, further comprising means for transmitting a disable signal instructing an emitting device to reduce emitting transmissions in a congested channel if no uncongested channels are available for transmitting said communication signal and said communication signal is a high-importance communication signal.

32. The communication system of claim 30, wherein said means for transmitting said communication signal increases the power level incrementally and repeatedly until said communication signal is received by said base station.

33. The communication system of claim 30, wherein said means for determining if said communication signal is a high-importance communication signal comprises a processor that determines if an emergency telephone call is being made by said portable communication device based on keystrokes entered on a keypad disposed on said portable communication device.

34. A communication device capable of reducing spectral congestion in order to transmit a high importance communication signal, the device comprising:
a transmitter configured to transmit a communication signal on a communication channel;
an input configured to receive a destination for said communication signal;
a processor configured to determine if said communication signal is a high-importance communication signal; and
wherein when said communication channel is congested and said communication signal is a high-importance communication signal, said transmitter transmits said communication signal at an increased power level on said communication channel.

35. The communication device of claim 34, wherein said input comprises a keypad.

36. The communication device of claim 34, wherein said input comprises a microphone.

37. The communication device of claim 34, wherein when said communication channel is congested and said communication signal is a high-importance communication signal said transmitter transmits a disable signal instructing an emitting device to reduce emitting transmissions in said communication channel.

38. The communication device of claim 34, wherein said communication device is one of a cordless telephone, a cellular telephone, a pager, a digital communication device, a personal digital assistant and a wireless local loop device.
